(19) United States
(12) Patent Application Publication
(10) Pub. No.: US 2026/0092805 A1
(43) Pub. Date: Apr. 2, 2026

(54) SYSTEMS AND METHODS FOR SINGLE DRAFT WEIGHING OF A MOVING VEHICLE

(71) Applicant: Rice Lake Weighing Systems, Inc., Rice Lake, WI (US)

(72) Inventors: Joseph GRELL, Rice Lake, WI (US); Dustin DUDLEY, Rice Lake, WI (US); Matt DAVIS, Rice Lake, WI (US); Derek SWEET, Rice Lake, WI (US)

(73) Assignee: Rice Lake Weighing Systems, Inc., Rice Lake, WI (US)

(21) Appl. No.: 19/340,343

(22) Filed: Sep. 25, 2025

Related U.S. Application Data
(60) Provisional application No. 63/700,248, filed on Sep. 27, 2024.

(51) Int. Cl. G01G 19/02; G01G 19/03; G01G 23/36; G01P 3/50

(52) U.S. Cl. CPC G01G 19/024; G01G 19/035; G01P 3/50; G01G 23/36

(57) ABSTRACT

Systems and methods for single draft weighing of a moving vehicle. A method includes providing a weighbridge disposed in the path of the moving vehicle, monitoring a signal from a weight sensor operably connected to the weighbridge for a weight sensor threshold to determine a scale entry time, sampling a stream of data based on the signal from the weight sensor as the vehicle moves across the weighbridge, wherein the sampling occurs for a predetermined data acquisition time duration; verifying that the entire weight of the vehicle was supported by the weighbridge for at least the data acquisition time duration; and in response to the verifying, calculating a single draft weight of the entire vehicle based on the sampled stream of data from the weight sensor.

### CROSS-REFERENCE TO RELATED APPLICATIONS

This application claims the benefit of priority to U.S. Provisional Ser. No. 63/700,248 , filed Sep. 27, 2024, which is hereby incorporated by reference in its entirety.

### BACKGROUND OF INVENTION

Conventional legal-for-trade, single draft vehicle scales require the vehicle to come to a stop on the scale. Use of these conventional system involves driving the vehicle onto the scale, stopping on the scale for some period of time, acquiring a vehicle weight, and printing a ticket. Statutory and regulatory requirements generally mandate that legal-for-trade weighments be completed using a single draft scale, and impose strict accuracy and precision requirements for the measurement. Legal-for-trade vehicle scales may be required to be accurate to 0.1% of the total measured weight, while also having a capacity of several hundred thousand pounds.

While many attempts have been made, accuracy requirements for legal-for-trade scales have to this point generally made it impossible or impractical using conventional technology to do away with the requirement of the vehicle coming to a complete stop on the scale. The practical necessity of stopping the vehicle on a conventional truck scale, however briefly, has many drawbacks including increased fuel consumption, increased carbon emissions, increased brake wear, longer wait times for drivers, and increased operational costs for scale operators. Furthermore, the practice of printing a physical ticket that must then be physically conveyed to the driver, who must then carefully retain the ticket for later inspection or audit, adds another layer of inefficiency.

Thus, it can be seen that improved systems and methods of single draft weighing of a vehicle are needed.

### SUMMARY OF THE INVENTION

Provided herein are systems and methods for of single draft weighing of a moving vehicle. The disclosed systems and methods overcome the primary obstacles for a legal-for-trade, single draft, weigh-in-motion truck scale, unlocking the potential for weighing a stream of trucks and other vehicles in a continuous manner. The disclosed systems and methods may thus offer at least one of the following advantages over conventional static weighing systems:
Increasing throughput by weighing trucks without stopping on the scale;
Cutting emissions by reducing idle time and lines of vehicles waiting to be weighed;
Reducing maintenance by limiting truck braking;
Improving site safety by ensuring drivers can complete transactions from their cabs;
Sending weight ticket pdfs to drivers via email and print tickets in the central office;
Interface with RFID readers or license plate cameras for quick truck identification.
Capture transaction photos with optional network-connected cameras.

The disclosed systems and methods may integrate a dedicated digital weight indicator and a DOT speed sensor to classify trucks and capture a weight. The disclosed systems and methods may also allow discrete data acquisition times and weight capture thresholds to be associated with individual vehicles, via for example, license plates, driver's license, or any other unique identifier of the driver and/or vehicle.

In some embodiments, all algorithms and associated calculations may be performed in an integrated digital weighing indicator with no additional external computer device required for the system.

In some embodiments, the disclosed systems and methods may employ a weight threshold value to indicate when a vehicle is completely on the weigh bridge. This technique may eliminates the need for photo eyes, or other sensors to determine when a vehicle is completely on a weighbridge.

In one embodiment, a method for single draft weighing of a moving vehicle comprises: providing a weighbridge disposed in the path of the moving vehicle; monitoring a signal from a weight sensor operably connected to the weighbridge to determine a scale entry time, the scale entry time corresponding to the point in time when the entire moving vehicle is first supported by the weighbridge, wherein monitoring the signal comprises: comparing the signal from the weight sensor to a predetermined weight sensor threshold; wherein if the signal from the weight sensor is below the weight sensor threshold, then continuing to compare the signal to the threshold; and wherein if the signal from the weight sensor exceeds the weight sensor threshold, then flagging the scale entry time; in response to flagging the scale entry time, sampling a stream of data based on the signal from the weight sensor as the vehicle moves across the weighbridge, wherein the sampling occurs for a predetermined data acquisition time duration; verifying that the entire weight of the vehicle was supported by the weighbridge for at least the data acquisition time duration, based on vehicle speed data; and in response to the verifying, calculating a single draft weight of the entire vehicle based on the sampled stream of data from the weight sensor.

In one embodiment, the signal from the weight sensor is an analog signal, and monitoring the signal may comprise: converting the analog signal to a digital signal; and filtering the digital signal, wherein the filtering comprises: segmenting the data into a series of data segments, wherein each subsequent data segment in the series corresponds to data collected over a subsequent time interval of a first duration; and calculating an average value of each data segment to produce a first stream of averages.

In one embodiment, filtering the digital signal comprises: calculating a second stream of averages by segmenting the first stream of averages into a series of average data segments, wherein each subsequent average data segment in the series corresponds to data collected over a subsequent time interval of a second duration, wherein the second duration is longer than the first duration; and calculating an average value of each average data segment to produce a second stream of averages.

In one embodiment, filtering the digital signal comprises: calculating a third stream of averages by segmenting the second stream of averages and calculating an average value of each respective segment to produce a third stream of averages.

In one embodiment, calculating the single draft weight comprises: deleting an initial portion of the recorded stream of data; deleting a terminal portion of the recorded stream of data; and calculating the single draft weight based on a remaining middle portion of the sampled stream of data.

In one embodiment, a method for single draft weighing of a moving vehicle comprises receiving vehicle identification information; and determining the weight sensor threshold by searching a data library of vehicle-specific weight sensor threshold values cross-referenced to vehicle identification information.

In one embodiment, a method for single draft weighing of a moving vehicle comprises: receiving vehicle identification information; and determining the data acquisition time duration by searching a data library of vehicle-specific data acquisition time duration values cross-referenced to vehicle identification information. In one embodiment, the vehicle identification information comprises one or more of: a vehicle identification number (VIN), a vehicle operator's driver's license number; and a license plate.

In one embodiment, a method for single draft weighing of a moving vehicle comprises calculating the data acquisition time duration, wherein calculating comprises: subtracting the length of the wheelbase of the moving vehicle from the length of the weighbridge to yield a distance, d; and dividing distance d by a maximum speed to yield a minimum data acquisition time duration. In one embodiment, the data acquisition time duration is selected from the range of 1 to 10 seconds. In one embodiment, the data acquisition time duration is selected from the range of 1.5 to 4 seconds.

In one embodiment, the step of verifying that the entire weight of the vehicle was supported by the weighbridge for at least the duration of the data acquisition time duration comprises: monitoring a speed of the vehicle via a speed sensor to produce the vehicle speed data. in one embodiment, monitoring the speed of the vehicle includes comparing the vehicle speed data against at least one of: a vehicle speed threshold and a vehicle change-in-speed threshold.

In one embodiment of a method for single draft weighing of a moving vehicle, when the vehicle acceleration threshold and/or the vehicle speed threshold is not exceeded, the system calculates the single draft weight of the entire vehicle; and when the vehicle change-in-speed threshold and/or the vehicle speed threshold is exceeded, an invalid weight signal is generated. In one embodiment, the vehicle speed threshold is selected from the range of 0.5-20 mph. In one embodiment, the vehicle speed threshold is selected from the range of 1-6 mph. In one embodiment, the vehicle change-in-speed threshold has a magnitude selected from the range of 1-3 mph.

In one embodiment, the weight sensor comprises a single-link suspension, double-ended shear beam supporting the weighbridge.

In one embodiment, a system for single draft weighing of a moving vehicle comprises: a weighbridge disposed in the path of the moving vehicle, wherein a length of the weighbridge is longer than a wheelbase of the moving vehicle; a weight sensor operably connected to the weighbridge; a speed sensor; and a processor operably connected to the weight sensor and speed sensor, the processor configured for: monitoring a signal from a weight sensor to determine a scale entry time, the scale entry time corresponding to the point in time when the entire moving vehicle is first supported by the weighbridge, wherein monitoring the signal comprises: comparing the signal from the weight sensor to a predetermined weight sensor threshold; wherein if the signal from the weight sensor is below the weight sensor threshold, then continuing to compare the signal to the threshold; and wherein if the signal from the weight sensor exceeds the weight sensor threshold, then flagging the scale entry time; in response to flagging the scale entry time, sampling a stream of data based on the signal from the weight sensor as the vehicle moves across the weighbridge, wherein the sampling occurs for a predetermined data acquisition time duration; verifying that the entire weight of the vehicle was supported by the weighbridge for at least the data acquisition time duration, based on vehicle speed data; and in response to the verifying, calculating a single draft weight of the entire vehicle based on the sampled stream of data from the weight sensor.

In one embodiment, the weight sensor comprises a single-link suspension, double-ended shear beam supporting the weighbridge. In one embodiment, the speed sensor is an entry speed sensor configured to sense the speed of the moving vehicle as it enters the weighbridge, the system further comprising an exit speed sensor configured to sense the speed of the moving vehicle as it exits the weighbridge. In one embodiment, the weight sensor may be rated to 200,000 pounds, measurable in 20 pound increments.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 is a schematic diagram showing the components of one exemplary embodiment of a system for single draft weighing of a vehicle.

FIG. 2 is a schematic diagram showing the steps of one exemplary embodiment of an automatic weighing mode of a system and/or method for single draft weighing of a vehicle.

FIG. 3 is a schematic diagram showing the steps of one exemplary embodiment of the weigh in/our process of a system and/or method for single draft weighing of a vehicle.

FIG. 4 is an illustration of one embodiment of GUI of a system and/or method for single draft weighing of a vehicle.

FIG. 5 is a table illustrating system parameters related to a GUI of a system and/or method for single draft weighing of a vehicle.

FIG. 6 is a schematic diagram showing error modes associated with steps of a system and/or method for single draft weighing of a vehicle.

FIGS. 7A and 7B are illustrations of a weighment ticket including a gross vehicle weight and speed (FIG. 7A) as well as a weighment ticket showing calculation of a net weight and speed (FIG. 7A).

FIG. 8 is a schematic diagram showing inputs to a method for single draft weighing of a vehicle.

FIG. 9 is a schematic diagram showing steps of a method for single draft weighing of a vehicle.

FIG. 10 is a schematic diagram showing components of a system for single draft weighing of a vehicle.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

### Definitions

As used herein, the term “single draft weighing” of a vehicle means weighing wherein the entire vehicle is weighed at one time (e.g., the entire vehicle is entirely supported by a single weighbridge). Single draft weighing does not include determining the weight of a vehicle by adding together the results obtained by separately weighing each end of the vehicle, or by separately weighing individual elements of such vehicle (e.g. axles).

As used herein, the term “weighbridge” means a platform configured for driving a vehicle on top of for the purpose of weighing the vehicle.

As used herein, the term “wheelbase” means the horizontal distance between the frontmost and rearmost axles of a vehicle. In some embodiments, the wheelbase may be augmented to consider tire deformation and the resultant contact patches of the frontmost and rearmost tires of the vehicle such that the wheelbase is the horizontal distance from the front of the contact patch of the tires of the foremost axle to the rear of the contact patch of the tires of the rearmost axle.

As used herein, the term “contact patch” means the portion of a vehicle's tire that is in actual contact with the road surface.

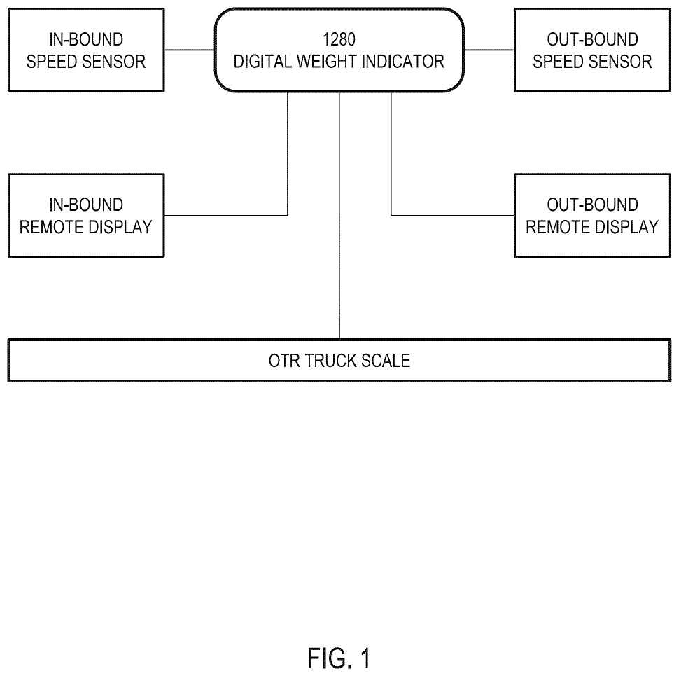

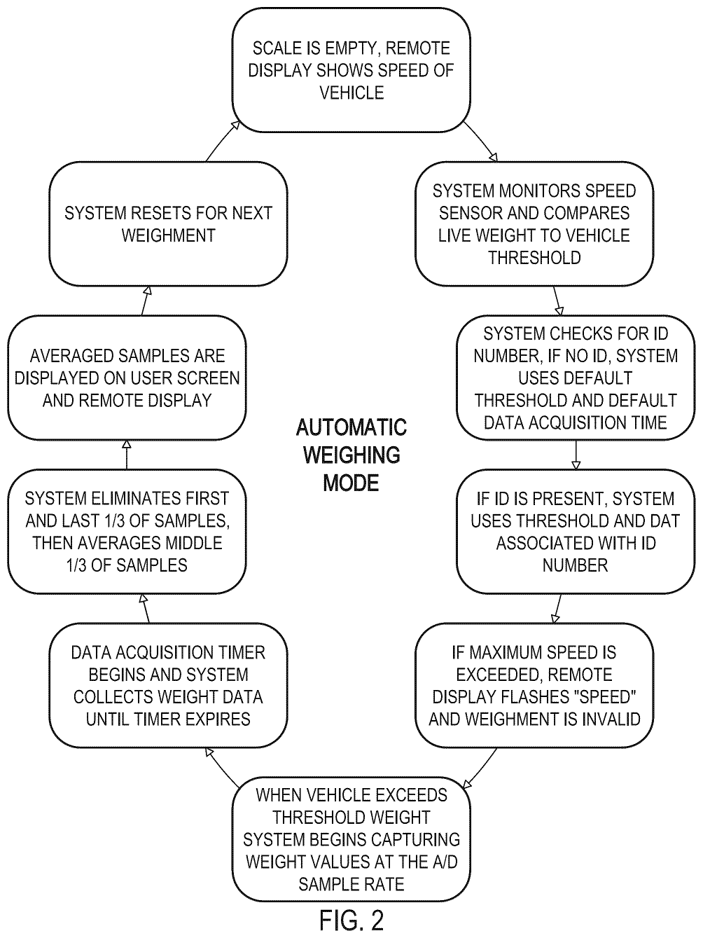

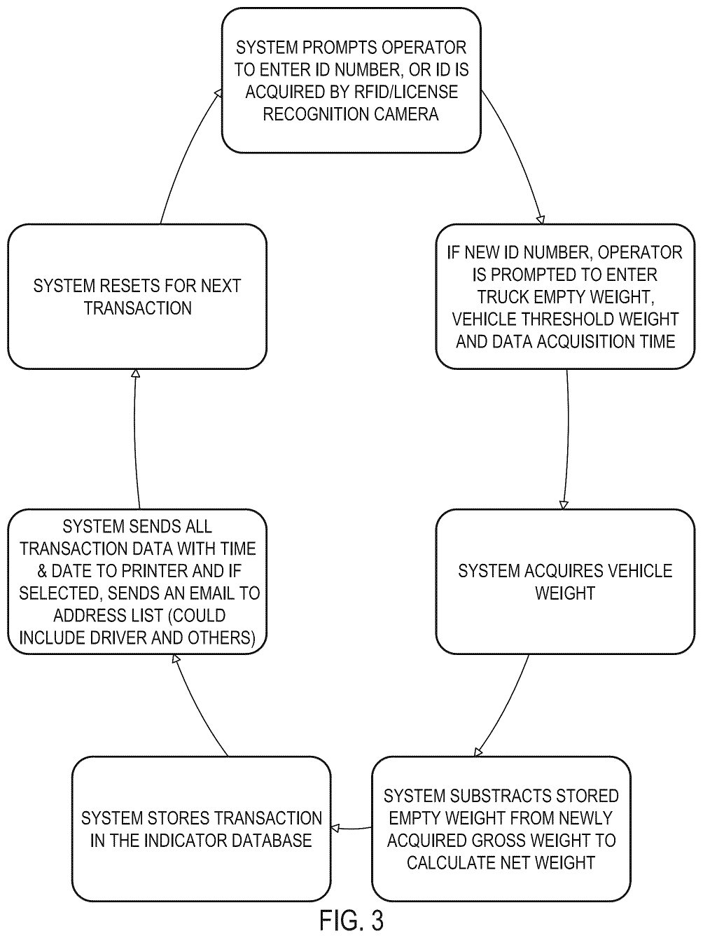

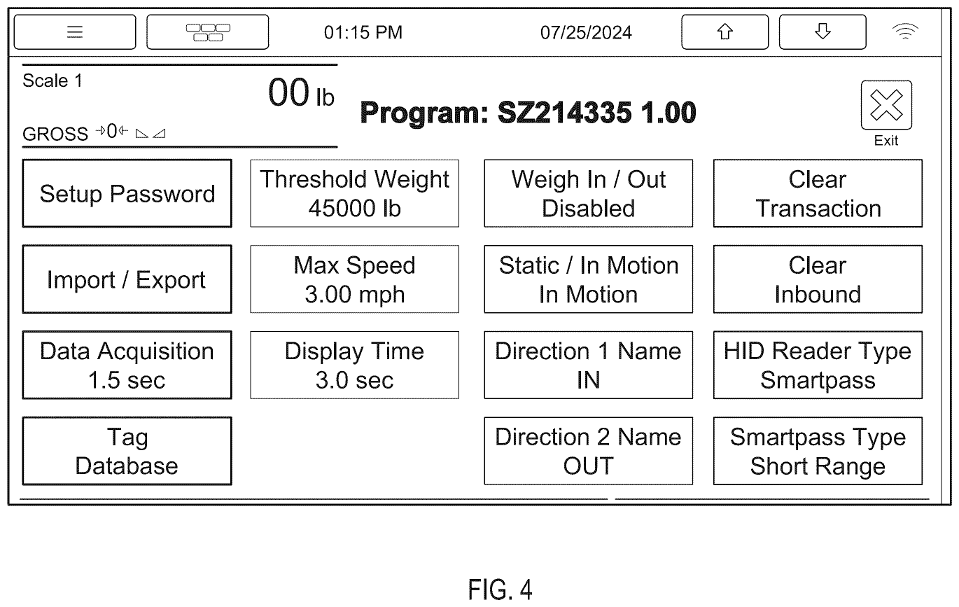

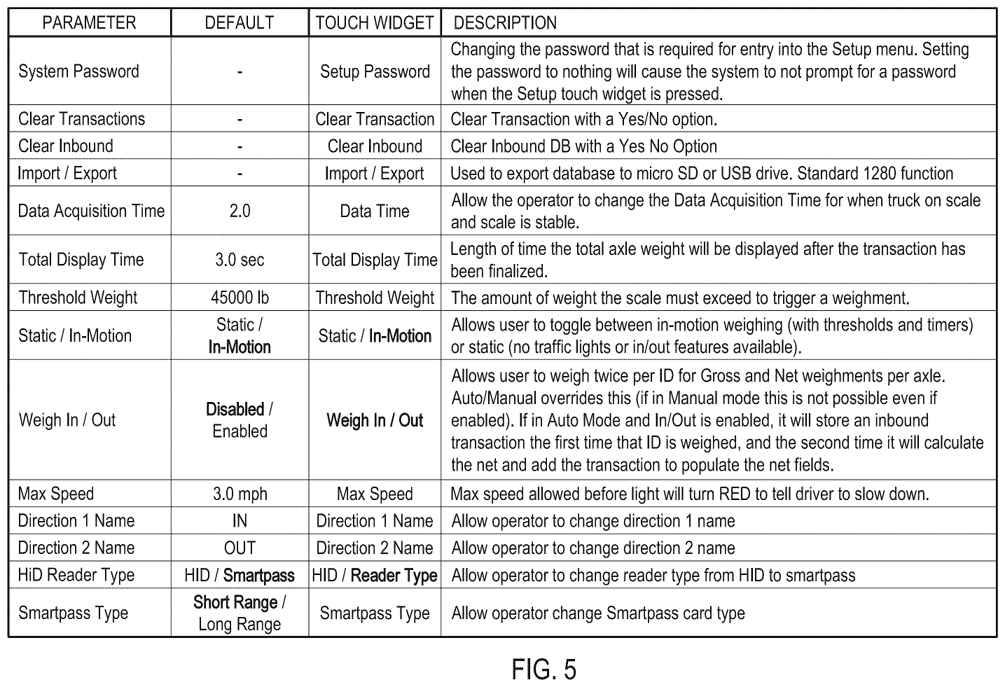

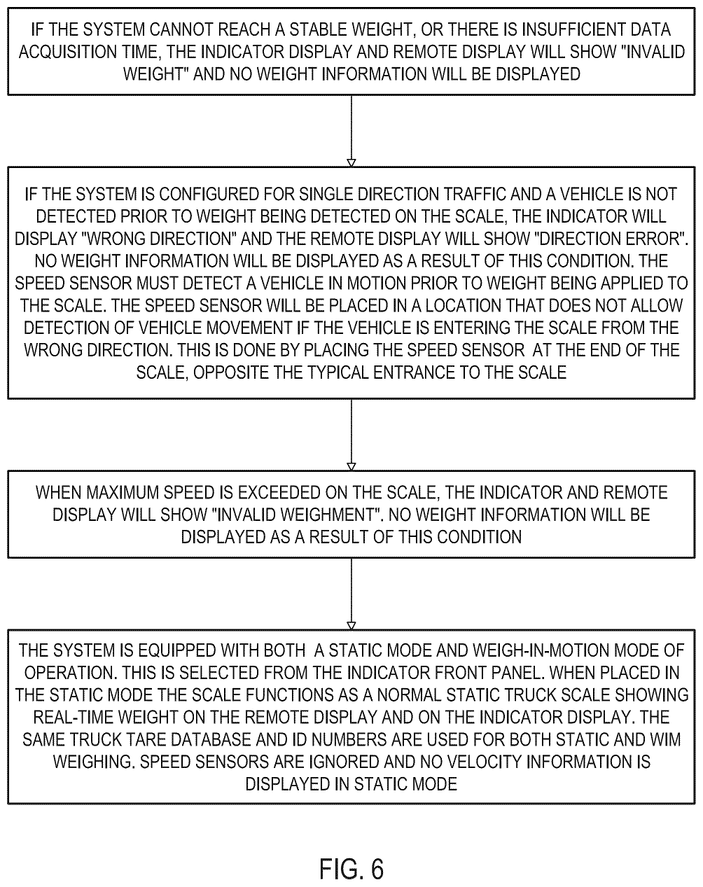

Turning now to FIG. 1, a schematic diagram showing the components of one exemplary embodiment of a system for single draft weighing of a vehicle is shown. The illustrated truck scale may include a number of Wheatstone bridge sensors (sometimes referred to as load cells), each with an associated suspension system that support a vehicle weigh bridge. As trucks pull on to the weigh bridge, force is transferred from the weighbridge through the suspension system to the load cell substrate. When the load cell substrate is deflected by the force from the weigh bridge, it stretches and compresses the strain gages that make up the Wheatstone bridge, allowing an excitation voltage that is applied to the Wheatstone bridge to pass a portion of the excitation voltage to a digital weight indicator. The signal that is passed by the Wheatstone bridge is proportional to the weight on the scale. Excitation voltages are typically 10 VDC. The signal from the load cell is typically 3 millivolts per volt of excitation. This configuration will yield a signal of 0 to 30 millivolts for a truck scale that can weigh vehicles from 0-600,000 pounds. Since legal highway vehicle loads are approximately 80,000 to 100,000 pounds, the actual signal used to weigh a vehicle is 0-5 millivolts.

In the illustrated embodiment, the analog load cells are connected to a digital weight indicator. The digital weight indicator does an analog to digital conversion. In th illustrated embodiment, the A/D (analog to digital converter) divides the available signal of 5 millivolts at 100,000 pounds, into 20 pound increments, each equal to 0.1 micro-volts per 20 pound graduation.

In some embodiments, enhance the stability of a displayed weight, the readings from the A/D may be averaged before they appear on the display. In one embodiment, the A/D runs at 30 updates per second. 128 updates may then be averaged and passed to a second filter that averages 256 updates and those results may then be sent to a third filter that averages 256 updates. These filters may be characterized as rolling filters, thus first in data is also the first out. New information may nevertheless be sent out of the A/D at a rate of 30 times per second and the raw information can take several seconds to completely cycle through the filters. For this reason, if a sharp increase or reduction in weight values is detected, the contents of the filter are discarded and the process starts over. The display may still update faster than a human can interpret the information (e.g., 5 times per second), but the display nevertheless updates less frequently than the A/D is processing the information.

The result of the filtering algorithm is a stable display that can change instantly with a change in force of as little as 20 pounds. For in-motion weighing, the A/D information is not processed until the vehicle threshold weight has been exceeded. At that point the vehicle may reliably be determined to be completely on the scale. The combination of a single link, double ended shear beam suspension system and the digital filtering algorithm allows the system to yield stable weight values while a vehicle is moving across the scale. Those stable weight values are then averaged for a predetermined “Data Acquisition Time”, (DAT) that is unique to each vehicle crossing the scale.

In one embodiment, the length of the vehicle is subtracted from the length of the scale to determine a distance, d, that the vehicle may drive while still remaining entirely on the scale. Next a calculation is performed to determine how far the vehicle can travel at a given speed. That calculation establishes the maximum speed for the vehicle and the amount of time the vehicle will be on the scale at that speed. In one embodiment, the weight of the vehicle can be sampled for as little as 1.5 seconds to get a valid weight, but it has been found that in some embodiment, 2-4 seconds will yield more consistent weight values. After the system averages the weight of the vehicle moving across the scale, the result is sent to a remote display and to a printer.

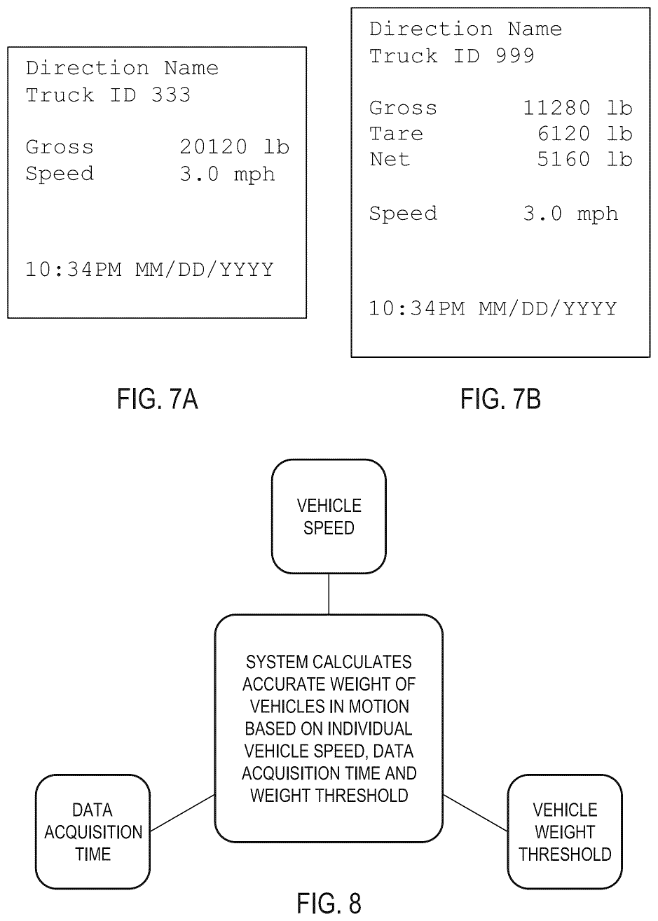

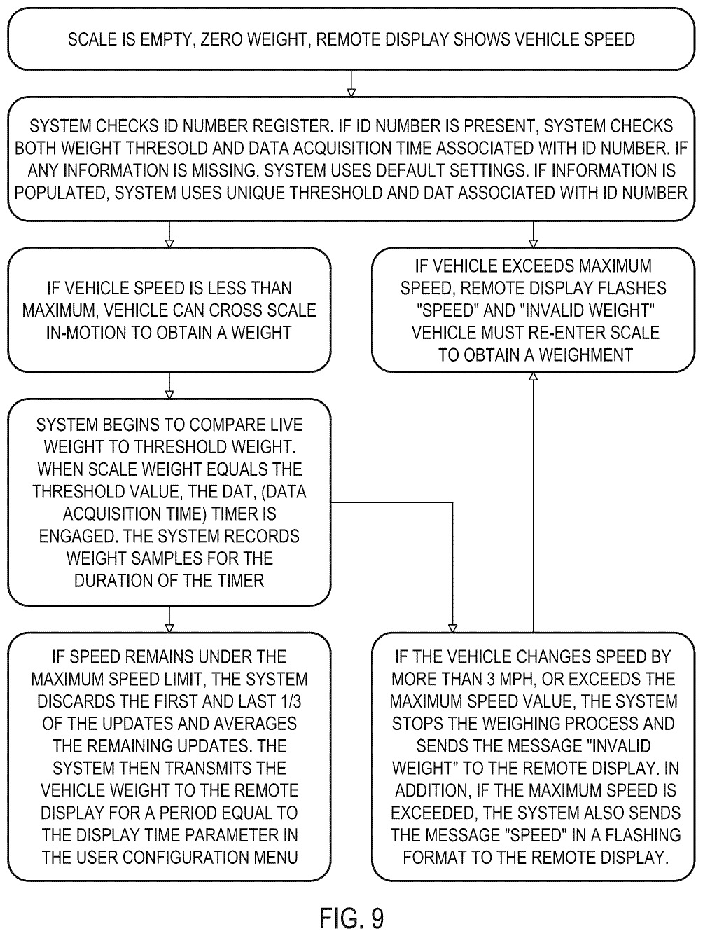

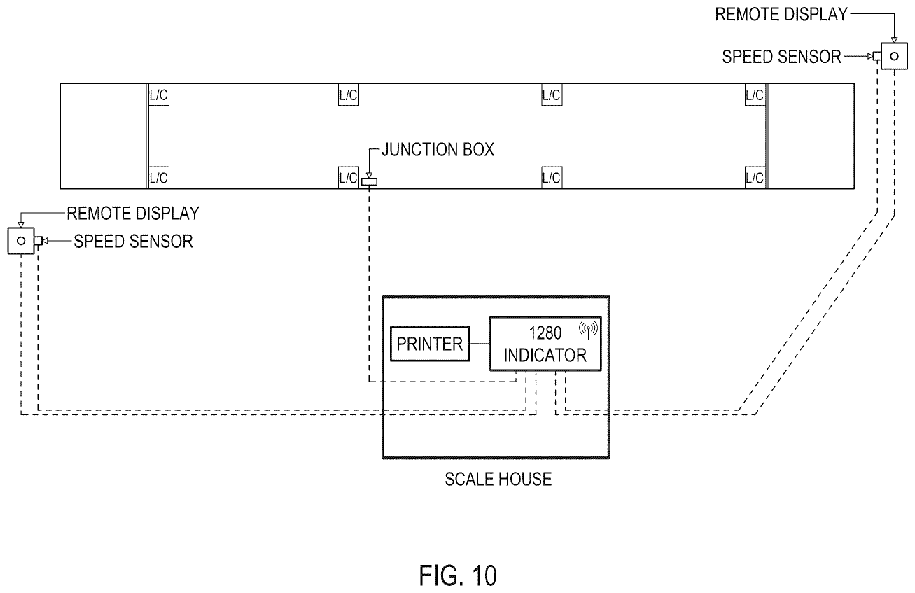

Turning now to FIGS. 7A and 7B, historically, vehicles have moved onto truck scales, stopped on the scale, the scale then acquires a weight and a ticket is printed. Systems and methods of the present disclosure allow vehicles to move across a truck scale at less than 6 MPH without stopping, then the scale captures a legal-for-trade weight and prints a ticket as well as transmits a ticket to the email address of the vehicle operator.

In some embodiments, both a weight threshold and a discrete data acquisition time may be associated with individual vehicle identification numbers. ID numbers may be entered for each weighment through a keyboard entry by an operator, RFID tags and readers, or license plate recognition cameras. Vehicle tare weights may also be associated with ID numbers to allow vehicles to be processed fully loaded, eliminating the need to weigh every vehicle both empty and full to determine net weight values.

Advantages of the disclosed systems and methods include carbon footprint/carbon emissions reduction, fuel savings, increased scale throughput, reduced operation costs and attraction of additional drivers who may have a choice in which system they use to processes their loads.

In one embodiment, the disclosed systems and methods may be retro-fit to an existing truck scale.

### Example 1—Accuracy and Error Mode Validation

Testing methods: The approach of the vehicle is detected by the optional speed sensor(s) when the steering tires first enter the platform. The optional speed sensor may define the direction of travel and the speed of the approaching vehicle.

When the front wheels first enter the platform, the weighing process begins. The system determines when the last axle of the vehicle is on the platform and begins the process of determining the vehicle's gross weight. The weighing process continues until the Data Acquisition Time is exceeded. The weighing process is stopped and the gross vehicle weight displayed to both the operator and the vehicle driver. Throughout the weighing process, the system monitors the action of the vehicle looking for any operational errors. If an error is detected, an error message is displayed for both the operator and the vehicle driver, and the weighing process is aborted.

### Error Messages:

Vehicle Approach Speed: The vehicle speed is detected by a speed sensor as the vehicle approaches the scale. If the vehicle's speed is greater than the system speed threshold a “Slow Down” message is displayed to both the operator and the vehicle driver. The speed indicator on the system screen turns red. If the vehicle is still above the system speed threshold an “Invalid Weight” message is displayed to both the operator and the vehicle driver.
Maximum Speed Exceeded: If, during the weighing process, the vehicle speed exceeds the maximum speed value, the weighing process is aborted an “Invalid Weight” message is displayed to both the operator and the vehicle driver.
Minimum Speed Error: If the vehicle's speed drops below the minimum speed value, the system switched from in-motion operation to a static weighing mode. When this occurs, the operator and the vehicle driver sees the vehicle's static weight and the message ‘Static” is displayed on the operator screen.
Vehicle Change Speed: If the vehicle's speed changes more than the change in speed value, the weighing process is aborted. And an “Invalid Weight” message is displayed to both the operator and the vehicle driver.
Directional Error: On a bi-directional system, if both speed sensors detect multiple vehicles both the operator and the vehicle driver see a ⋅“DIR-ERR” or a “DIRECTION ERROR” message.
Insufficient Data Acquisition Time: In the event that the vehicle is not on the scale for the required Data Acquisition Time, the weighing process is aborted, and an “Invalid Weight” message is displayed to both the operator and the vehicle driver.
Vehicle stopped on the Scale: If the vehicle comes to a stop of the scale, the weighing process is aborted, and the operator and the Vehicle driver sees the vehicle's static weight and the message “Static” is displayed on the operators screen.
Vehicle is off either side of the platform: This error is not applicable to this system as the platform must have guard rails which prevent the vehicle from going off either side of the platform.

Test conditions: The system consisted of a 80′×11′, 120 000 lb×20 lb, (4 section) Model E7 80 11-100 (C′C: 02-003) combination concrete and steel deck weighing/load receiving element, using a Rice Lake Weighing System Model RL 75058-LP-75K. (CC: 98-143) load cells and a Rice Lake Weighing Systems Model I 280-2A (CC. 15-00 I) indicating element. The Model EZ 8011-100 weighing/load receiving element's performance was verified for use as the reference scale for determining the weight of the reference vehicles. Performance was verified to be less than ⅓ the value of the increment (e) value. Four different reference vehicle types were used during the evaluation. Three of the vehicle types were loaded to three different loading conditions and run across the scale a minimum of five times in each direction varying from near minimum to near maximum speeds. In addition, a half-loaded Class 6 tanker was run across the scale five times in each direction with varying speeds. All weighments were within applicable tolerances.

The System's speed detection was verified using the timing method with a certified. Throughout the testing. various error conditions were created to verify correct performance. All error conditions were detected and displayed to both the system operator and the vehicle driver.

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately.

When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method for single draft weighing of a moving vehicle, the method comprising:
providing a weighbridge disposed in the path of the moving vehicle, wherein a length of the weighbridge is longer than a wheelbase of the moving vehicle;
monitoring a signal from a weight sensor operably connected to the weighbridge to determine a scale entry time, the scale entry time corresponding to the point in time when the entire moving vehicle is first supported by the weighbridge, wherein monitoring the signal comprises:
comparing the signal from the weight sensor to a predetermined weight sensor threshold;
wherein if the signal from the weight sensor is below the weight sensor threshold, then continuing to compare the signal to the threshold; and
wherein if the signal from the weight sensor exceeds the weight sensor threshold, then flagging the scale entry time;
in response to flagging the scale entry time, sampling a stream of data based on the signal from the weight sensor as the vehicle moves across the weighbridge, wherein the sampling occurs for a predetermined data acquisition time duration;
verifying that the entire weight of the vehicle was supported by the weighbridge for at least the data acquisition time duration, based on vehicle speed data;
in response to the verifying, calculating a single draft weight of the entire vehicle based on the sampled stream of data from the weight sensor.

2. The method of claim 1, wherein the signal from the weight sensor is an analog signal, and wherein monitoring the signal comprises:
converting the analog signal to a digital signal; and
filtering the digital signal, wherein the filtering comprises:
segmenting the data into a series of data segments, wherein each subsequent data segment in the series corresponds to data collected over a subsequent time interval of a first duration; and
calculating an average value of each data segment to produce a first stream of averages.

3. The method of claim 2, wherein filtering the digital signal comprises:
calculating a second stream of averages by segmenting the first stream of averages into a series of average data segments, wherein each subsequent average data segment in the series corresponds to data collected over a subsequent time interval of a second duration, wherein the second duration is longer than the first duration; and
calculating an average value of each average data segment to produce a second stream of averages.

4. The method of claim 3, wherein filtering the digital signal comprises:
calculating a third stream of averages by segmenting the second stream of averages and calculating an average value of each respective segment to produce a third stream of averages.

5. The method of claim 1, wherein calculating the single draft weight comprises:
deleting an initial portion of the recorded stream of data;
deleting a terminal portion of the recorded stream of data; and
calculating the single draft weight based on a remaining middle portion of the sampled stream of data.

6. The method of claim 1, comprising:
receiving vehicle identification information; and
determining the weight sensor threshold by searching a data library of vehicle-specific weight sensor threshold values cross-referenced to vehicle identification information.

7. The method of claim 1, comprising:
receiving vehicle identification information; and
determining the data acquisition time duration by searching a data library of vehicle-specific data acquisition time duration values cross-referenced to vehicle identification information.

8. The method of claim 6, wherein the vehicle identification information comprises one or more of:
a vehicle identification number (VIN), a vehicle operator's driver's license number; and a license plate.

9. The method of claim 1, comprising calculating the data acquisition time duration, wherein calculating comprises:
subtracting the length of the wheelbase of the moving vehicle from the length of the weighbridge to yield a distance, d; and
dividing distance d by a maximum speed to yield a minimum data acquisition time duration.

10. The method of claim 1, wherein the data acquisition time duration is selected from the range of 1 to 10 seconds.

11. The method of claim 1, wherein the data acquisition time duration is selected from the range of 1.5 to 4 seconds.

12. The method of claim 1, wherein verifying that the entire weight of the vehicle was supported by the weighbridge for at least the duration of the data acquisition time duration comprises monitoring a speed of the vehicle via a speed sensor to produce the vehicle speed data.

13. The method of claim 12, wherein monitoring the speed of the vehicle includes comparing the vehicle speed data against at least one of: a vehicle speed threshold and a vehicle change-in-speed threshold.

14. The method of claim 13, wherein:
when the vehicle acceleration threshold and/or the vehicle speed threshold is not exceeded, the system calculates the single draft weight of the entire vehicle; and
when the vehicle change-in-speed threshold and/or the vehicle speed threshold is exceeded, an invalid weight signal is generated.

15. The method of claim 13, wherein the vehicle speed threshold is selected from the range of 0.5-20 mph.

16. The method of claim 13, wherein the vehicle change-in-speed threshold has a magnitude selected from the range of 1-3 mph.

17. The method of claim 1, wherein the weight sensor comprises a single-link suspension, double-ended shear beam supporting the weighbridge.

18. A system for single draft weighing of a moving vehicle, the system comprising:
a weighbridge disposed in the path of the moving vehicle, wherein a length of the weighbridge is longer than a wheelbase of the moving vehicle;
a weight sensor operably connected to the weighbridge;
a speed sensor; and
a processor operably connected to the weight sensor and speed sensor, the processor configured for:
monitoring a signal from a weight sensor to determine a scale entry time, the scale entry time corresponding to the point in time when the entire moving vehicle is first supported by the weighbridge, wherein monitoring the signal comprises:
comparing the signal from the weight sensor to a predetermined weight sensor threshold;
wherein if the signal from the weight sensor is below the weight sensor threshold, then continuing to compare the signal to the threshold; and
wherein if the signal from the weight sensor exceeds the weight sensor threshold, then flagging the scale entry time;
in response to flagging the scale entry time, sampling a stream of data based on the signal from the weight sensor as the vehicle moves across the weighbridge, wherein the sampling occurs for a predetermined data acquisition time duration;
verifying that the entire weight of the vehicle was supported by the weighbridge for at least the data acquisition time duration, based on vehicle speed data; and
in response to the verifying, calculating a single draft weight of the entire vehicle based on the sampled stream of data from the weight sensor.

19. The system of claim 18, wherein the weight sensor comprises a single-link suspension, double-ended shear beam supporting the weighbridge.

20. The system of claim 18, wherein the speed sensor is an entry speed sensor configured to sense the speed of the moving vehicle as it enters the weighbridge, the system further comprising an exit speed sensor configured to sense the speed of the moving vehicle as it exits the weighbridge.
